(19) United States
(12) Patent Application Publication
(10) Pub. No.: US 2016/0292361 A1
(43) Pub. Date: Oct. 6, 2016

(54) Data Collection and Recommendation System

(71) Applicant: Sean Martin, Elk Grove, CA (US)

(72) Inventor: Sean Martin, Elk Grove, CA (US)

(21) Appl. No.: 14/676,778

(22) Filed: Apr. 1, 2015

(51) Int. Cl. G06F 19/00; G06F 17/30

(52) U.S. Cl. CPC G06F 19/322; G06F 17/30312; G06F 19/3443; G06F 19/3481; G06F 19/363

(57) ABSTRACT

A data collection and recommendation system collect data and a recommendation is generated. The information collected may be, for example, data from patients getting general blood tests. This information can include age, lifestyle, sex, and blood test results. A user accessing the system may receive a recommendation that is based on real user information. For example, a user with elevated cholesterol may be able to see that an additional 20 minutes of exercise, 4-5 days a week, could result, based on others in this same age range, in a reduction in total cholesterol of 15 points. Such a recommendation provides a user with concrete, real data that can be used to motivate and lead the user toward their goal. The system may be used not only for medical information, but in any area where data is collected and a recommendation made based on the data.

### BACKGROUND OF THE INVENTION

The present invention relates to a data collection and recommendation systems and, more particularly, to systems, software and methods for collecting data from various sources, for example, by delivering a survey to users or accessing data from a third party database, and providing recommendations based on other data obtained.

There are many areas in which a person would like to compare themselves to others to determine their goals. For example, when a person gets a report from a blood test, they typically receive their result alongside a suggested range for that particular test. While these reports provide a goal, they do not offer any recommendations to arrive at that goal.

A physician may provide a patient with suggestions to help achieve a certain goal. For example, a doctor may recommend additional exercise to help correct an elevated total cholesterol level. However, these recommendations are usually not backed up by actual data. A patient may not be motivated to exercise a given amount when the doctor seems to be making a generalized recommendation.

As can be seen, there is a need for a data collection and recommendation system that can take a user's information and provide a recommendation based upon actual data of other individuals.

### SUMMARY OF THE INVENTION

In one aspect of the present invention, a system for providing a recommendation to a user comprises a first computing device; and a database attached to the first computing device, wherein the database stores information about a plurality of individuals, the information including at least a first attribute and a second attribute about each individual; and the first computing device receiving the information and providing a recommendation as an output, the recommendation determined by comparing the first attribute and the second attribute of the user to the first attribute and the second attribute of the plurality of individuals, where the recommendation applies a variation to at least one of the first attribute and the second attribute of the user and provides a determination of how the variation affects, on average, a change in at least one of the first attribute and the second attribute of the plurality of individuals.

In another aspect of the present invention, a method for providing a recommendation to a user comprises receiving data into a database, the data including at least a first attribute and a second attribute about each individual; querying the data by a computing device to calculate a recommendation, the recommendation determined by comparing the first attribute and the second attribute of the user to the first attribute and the second attribute of the plurality of individuals, where the recommendation applies a variation to at least one of the first attribute and the second attribute of the user and provides a determination of how the variation affects, on average, a change in at least one of the first attribute and the second attribute of the plurality of individuals; and providing an output of the recommendation.

In a further aspect of the present invention, a method for providing a patient with a healthcare recommendation based upon a plurality of peers comprises receiving data into a database, the data including at least a first attribute about each of the plurality of peers; querying the data by a computing device to calculate a recommendation, the recommendation determined by comparing the first attribute of the user to the first attribute of the plurality of peers, where the recommendation applies a variation to the first attribute of the user and provides a determination of how the variation affects, on average, a change in the first attribute of the plurality of peers; and providing an output of the recommendation.

These and other features, aspects and advantages of the present invention will become better understood with reference to the following drawings, description and claims.

### BRIEF DESCRIPTION OF THE DRAWINGS

FIG. 1 is a schematic representation of a system according to an exemplary embodiment of the present invention; and

FIG. 2 is a flow chart describing an exemplary embodiment of a method for providing a recommendation.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a data collection and recommendation system that obtains information and a recommendation is generated. For example, the information may be data from patients getting general blood tests performed. This data can include age, lifestyle, sex, and blood test results. A physician, or any user accessing the system, may receive a recommendation that is based on real user information. For example, a user with elevated cholesterol may be able to see that, for his or her age range, an additional 20 minutes of exercise, 4-5 days a week, could result, based on others in this same age range, in a reduction in total cholesterol of 15 points. Such a recommendation provides a user with concrete, real data that can be used to motivate and lead the user toward their goal. The system may be used not only for medical information, but in any area where data can be collected and a recommendation made based on the data obtained.

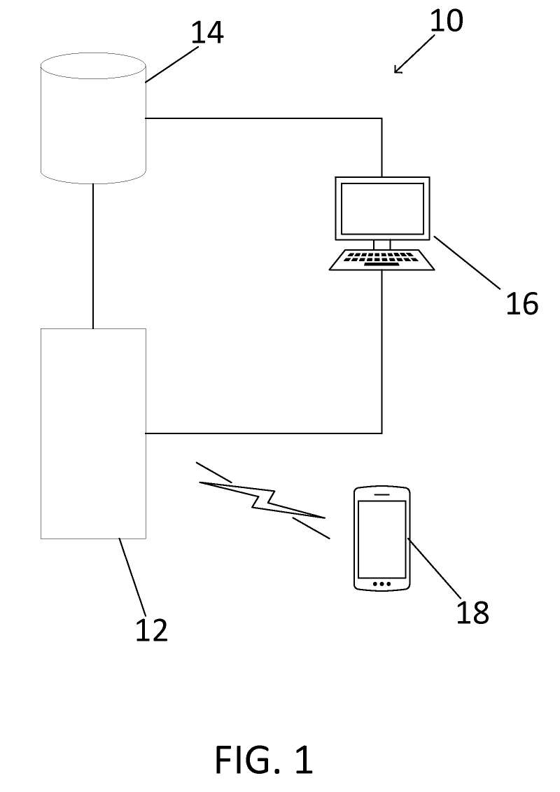

Referring now to FIG. 1, a system 10 an include a server 12 having a central processing unit, memory and software designed to perform the functions described below. The server 12 may be a physical computing device, a cloud-based system or the like. The server 12 may include or be connected to send and receive information from a database 14. The database 14 may store information to be used by the server 12 to perform various queries.

For example, in a medical recommendation system, the server 12 may be used to obtain data such as a patient's age, weight, blood test results, sex, lifestyle (smoking, alcohol use, and the like), and other such data. This data can be stored in the database 14. The server 12 may be used to query the database 14.

The data in the database 14 can be populated in various manners. The data may be imported from a laboratory that performs blood testing for many physicians. In this embodiment, specific patient identifying information may be removed from the data for confidentiality, as the data is used for statistical purposes in providing a recommendation. In some embodiments, the data may be obtained from the patient's medical record. In some embodiments, a survey may be provided to a user on a computing device 16, 18. The computing device may be a wired computing device 16 that may be coupled to transmit data to and from the server 12 and the database 14, or the computing device may be a wireless computing device 18, such as a smartphone, tablet, or the like.

The computing devices 16, 18 may allow a user to transmit their data into the system 10. In some embodiments, the computing devices 16, 18 may also allow the user to obtain a recommendation from the system. In other embodiments, a physician may access the system 10 to be the source of one or more recommendations for the patient.

One example of the survey and recommendation system is provided below. While this is a medical-based example, it should be understood that the system of the present invention can be used in any situation where data is collected and a recommendation may be made based on the collected data.

A sample of some survey questions include, but are not limited to the following:
1. Male______ Female______
2. Age______
3. Height______
4. Weight______
5. Do you take Vitamin D: ______Yes ______No
6. How many days a week do you get 15+ minutes of sunlight: ______1 ______2 ______3 ______4 ______5 ______6 ______7
7. How many days a week do you exercise: ______1 ______2 ______3 ______4 ______5 ______6 ______7
8. What is your average workout time: ______.
   A sample of recommendations include, but are not limited to the following:
1. Males of your age, who received 15 min of sunlight 5 plus times a week, had an average of XX higher volumes of vitamin D in their blood.
2. Females your age and height, who exercised ______days more per week, weighed an average of YY pounds less.

In some embodiments, the recommendations may be pre-set based on the data obtained. In other embodiments, the user may be allowed to send specific queries to the server 12. For example, a user may be able to fix the sex, age and weight, and show a vitamin D recommendation. In this example, the recommendation would be based on users of the same sex, age and weight. Therefore, the value of XX above may vary depending on which variables are fixed.

In this regard, the system of the present invention may be useful to show trends or provide more detailed recommendations. For example, the system may be used to provide a user with a recommendation that their vitamin D levels would be XX greater with 15 minutes a day additional sun exposure, but if they lose 30 pounds, they could achieve the same XX amount of vitamin D levels with only 10 minutes a day of additional sun exposure. In this example, a user can see how not only additional sun exposure may help increase their results, but also how other variables (such as weight) can also have an effect.

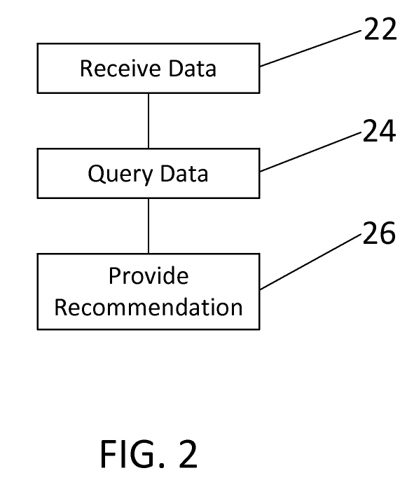

FIG. 2 shows an exemplary method of providing a recommendation based on actual data. In step 22, the system receives data. This data can include demographic data, age, sex, lifestyle, medical test results, and the like. In step 24, the data is queried. This query can be an automatic query or may be manually requested by the user. The query can be, for example, if age is constant, what would my vitamin D level be if I received 15 more minutes of sun exposure a day. The output from the system, in step 26, can be a recommendation. This recommendation may be, for example, if you get 15 more minutes of sunlight exposure a day, your vitamin D levels would raise by 10 points, based on real statistical records of someone of your age and sex.

As discussed above, the system of the present invention can be used to receive data from various sources and process that data to provide a recommendation. While the above examples are in the medical field, the recommendation may be in any area. For example, drivers may be surveyed of their driving habits and their gas mileage. The recommendation could be that if the driver reduced their speed to not more than 5 miles above a posted speed limit, their gas mileage would improve by 2 miles per gallon. Like the medical recommendations, this recommendation could be based on a certain car model, driving conditions or the like.

It should be understood, of course, that the foregoing relates to exemplary embodiments of the invention and that modifications may be made without departing from the spirit and scope of the invention as set forth in the following claims.

What is claimed is:

1. A system for providing a recommendation to a user, the system comprising:
a first computing device; and
a database attached to the first computing device, wherein
the database stores information about a plurality of individuals, the information including at least a first attribute and a second attribute about each individual;
the first computing device receiving the information and providing a recommendation as an output, the recommendation determined by comparing the first attribute and the second attribute of the user to the first attribute and the second attribute of the plurality of individuals, where the recommendation applies a variation to at least one of the first attribute and the second attribute of the user and provides a determination of how the variation affects, on average, a change in at least one of the first attribute and the second attribute of the plurality of individuals.

2. The system of claim 1, further comprising at least one computing device for entering survey information into the database.

3. The system of claim 2, wherein the at least one computing device is a mobile computing device.

4. The system of claim 1, wherein the first attribute is a physical attribute.

5. The system of claim 4, wherein the second attribute is a test result.

6. The system of claim 4, wherein the physical attribute is at least one of age, sex and weight.

7. A method for providing a recommendation to a user, comprising:
receiving data into a database, the data including at least a first attribute and a second attribute about each individual;
querying the data by a computing device to calculate a recommendation, the recommendation determined by comparing the first attribute and the second attribute of the user to the first attribute and the second attribute of the plurality of individuals, where the recommendation applies a variation to at least one of the first attribute and the second attribute of the user and provides a determination of how the variation affects, on average, a change in at least one of the first attribute and the second attribute of the plurality of individuals; and
providing an output of the recommendation.

8. The method of claim 7, further comprising entering survey information by the user into the database.

9. The method of claim 7, wherein the first attribute is a physical attribute.

10. The method of claim 9, wherein the second attribute is a test result.

11. The system of claim 9, wherein the physical attribute is at least one of age, sex and weight.

12. A method for providing a patient with a healthcare recommendation based upon a plurality of peers, the method comprising:
receiving data into a database, the data including at least a first attribute about each of the plurality of peers;
querying the data by a computing device to calculate a recommendation, the recommendation determined by comparing the first attribute of the user to the first attribute of the plurality of peers, where the recommendation applies a variation to the first attribute of the user and provides a determination of how the variation affects, on average, a change in the first attribute of the plurality of peers; and
providing an output of the recommendation.

13. The method of claim 12, wherein the plurality of peers have at least one attribute in common with the user.

14. The method of claim 13, wherein the database includes data on a plurality of individuals from which the plurality of peers is chosen.

15. The method of claim 12, further comprising entering survey information by the user into the database.

16. The method of claim 12, wherein the first attribute is a test result.
